(19) United States
(12) Patent Application Publication
(10) Pub. No.: US 2024/0380096 A1
(43) Pub. Date: Nov. 14, 2024

(54) DISPLAY ANTENNA

(71) Applicant: NEC Corporation, Tokyo (JP)

(72) Inventors: Ryota NIHEI, Tokyo (JP); Shingo Watanabe, Tokyo (JP); Fujio Okumura, Kanagawa (JP)

(73) Assignee: NEC Corporation, Tokyo (JP)

(21) Appl. No.: 18/642,879

(22) Filed: Apr. 23, 2024

(30) Foreign Application Priority Data
May 9, 2023 (JP) 2023-077101

(51) Int. Cl. H01Q 1/24; G06F 3/041; H01Q 1/48; H01Q 21/06

(52) U.S. Cl. CPC H01Q 1/243; G06F 3/0412; H01Q 1/48; H01Q 21/065

(57) ABSTRACT

Provided is a display antenna including a display including a plurality of light emitters arranged in a lattice pattern, a touch sensor that is disposed to overlap the display and in which a plurality of touch electrodes transmitting light in a wavelength band of a visible region are arranged in a lattice pattern, and an antenna array that is disposed to overlap the touch sensor and in which a plurality of patch antennas transmitting the light in the wavelength band of the visible region are arranged in a lattice pattern. The touch electrode also serves as a ground electrode of the patch antenna disposed above the touch electrode.

This application is based upon and claims the benefit of priority from Japanese Patent Application No. 2023-077101, filed on May 9, 2023, the disclosure of which is incorporated herein in its entirety by reference.

### TECHNICAL FIELD

The present disclosure relates to a display antenna.

### BACKGROUND ART

For mobile communication after the fifth generation mobile communication system (5G), planar antennas associated to radio waves in a frequency band higher than that in systems before the fourth generation mobile communication system (4G) have been developed. A planar phased array antenna can be configured using an antenna array having a configuration in which patch antennas are arranged in an array. The antenna array configured by a plurality of patch antennas can also function as a touch sensor (touch panel).

PTL 1 (JP 2003-280815 A) discloses a resistive touch panel that is used in an input device of an information processing device. The touch panel disclosed in PTL 1 is a resistive touch panel. The touch panel disclosed in PTL 1 A is characterized in that an antenna element is formed on an upper surface of an upper electrode substrate having a lower surface to which a transparent conductive film is fixed.

PTL 2 (JP 2009-158743 A) discloses a semiconductor device for suppressing occurrence of dielectric loss while reducing the size of the device. The device disclosed in PTL 2 includes a semiconductor element and a through electrode that is formed to penetrate the semiconductor element. The device disclosed in PTL 2 has a structure in which a passive layer connected to the through electrode is stacked on a surface opposite to a main surface of the semiconductor element with an inorganic insulating layer interposed therebetween.

PTL 3 (JP 2019-053343 A) discloses a touch panel with a built-in antenna that includes a touch panel and an antenna reading information using near field communication. The touch panel includes a first electrode and a second electrode. The antenna is provided in at least one of the first electrode layer and the second electrode layer of the touch panel.

In the touch panel disclosed in PTL 1, an antenna is formed in the touch panel by the antenna element formed on the upper surface of the upper electrode substrate. In the configuration disclosed in PTL 1, since the antenna is formed by the antenna element formed on the upper surface of the upper electrode substrate, the shape or size of the antenna is limited by the structure of the touch panel. The method disclosed in PTL 1 can be applied to the resistive touch panel, but it is not possible to apply the method to a touch panel, such as a capacitive touch panel, other than the resistive touch panel.

In the configuration disclosed in PTL 2, a patch antenna and a ground layer are stacked by the through electrode formed to penetrate the semiconductor element. The structure disclosed in PTL 2 corresponds to a basic structure of the patch antenna. PTL 2 does not disclose a structure in which the antenna and the touch panel coexist.

In the configuration disclosed in PTL 3 the antenna is provided in the electrode layer included in the touch panel. With this configuration, the thickness of the touch panel with a built-in antenna disclosed in PTL 3 is reduced. In the configuration disclosed in PTL 3, since the antenna is provided in the electrode layer included in the touch panel, the shape or size of the antenna is limited by the structure of the touch panel.

An object of the present disclosure is to provide a display antenna in which a touch sensor and an antenna can be set independently.

### SUMMARY

A display antenna according to an aspect of the present disclosure include a display including a plurality of light emitters arranged in a lattice pattern, a touch sensor that is disposed to overlap the display and in which a plurality of touch electrodes transmitting light in a wavelength band of a visible region are arranged in a lattice pattern, and an antenna array that is disposed to overlap the touch sensor and in which a plurality of patch antennas transmitting the light in the wavelength band of the visible region are arranged in a lattice pattern. The touch electrode also serves as a ground electrode of the patch antenna disposed above the touch electrode.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a display antenna according to the present disclosure;

FIG. 2 is a conceptual diagram illustrating an example of an antenna assembly configured by an antenna array included in a display antenna according to the present disclosure;

FIG. 3 is a conceptual diagram illustrating an example of a touch sensor included in a display antenna according to the present disclosure;

FIG. 4 is a cross-sectional view illustrating an example of an internal configuration of a display antenna according to the present disclosure;

FIG. 5 is a conceptual diagram illustrating an example of switching between a patch antenna and a touch electrode included in a display antenna according to the present disclosure;

FIG. 6 is a conceptual diagram illustrating an example of the switching between a patch antenna and a touch electrode included in a display antenna according to the present disclosure;

FIG. 7 is a conceptual diagram illustrating an example of the switching between a patch antenna and a touch electrode included in the display antenna according to the present disclosure;

FIG. 8 is a cross-sectional view illustrating an example of the internal configuration of a display antenna according to the present disclosure;

FIG. 9 is a conceptual diagram illustrating an example of a configuration of a display included in a display antenna according to the present disclosure;

FIG. 10 is a conceptual diagram illustrating an example of the configuration of a display included in a display antenna according to the present disclosure;

FIG. 11 is a conceptual diagram illustrating an example of a configuration of a phase shifter included in a display antenna according to the present disclosure;

FIG. 12 is a conceptual diagram illustrating an example of the configuration of the phase shifter included in a display antenna according to the present disclosure;

FIG. 13 is a conceptual diagram illustrating an example of the configuration of the phase shifter included in a display antenna according to the present disclosure;

FIG. 14 is a conceptual diagram illustrating an example of a user interface that is displayed on a screen of a terminal device provided with a display antenna according to the present disclosure;

FIG. 15 is a cross-sectional view illustrating an example of an internal configuration of a display antenna according to the present disclosure;

FIG. 16 is a conceptual diagram illustrating an example of a configuration of a switch included in a display antenna according to the present disclosure;

FIG. 17 is a cross-sectional view illustrating an example of an internal configuration of a display antenna according to the present disclosure;

FIG. 18 is a cross-sectional view illustrating an example of an internal configuration of a display antenna according to the present disclosure;

FIG. 19 is a cross-sectional view illustrating an example of an internal configuration of a display antenna according to the present disclosure;

FIG. 20 is a block diagram illustrating an example of a configuration of a display antenna according to the present disclosure;

FIG. 21 is a cross-sectional view illustrating an example of the internal configuration of a display antenna according to the present disclosure;

FIG. 22 is a conceptual diagram illustrating electromagnetic coupling between a patch antenna and a phase shifter of a display antenna according to the present disclosure;

FIG. 23 is a block diagram illustrating an example of a configuration of a display antenna according to the present disclosure; and

FIG. 24 is a block diagram illustrating an example of a hardware configuration that executes control or processes according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a display antenna according to a first example embodiment will be described with reference to the drawings. The display antenna according to the present example embodiment has functions of a touch sensor (touch panel) and an antenna. In the present example embodiment, an example in which an antenna assembly is configured by a plurality of patch antennas will be described. The antenna assembly functions as a phased array antenna. In the present example embodiment, a ground electrode of the patch antenna functions as the touch sensor.

### (Configuration)

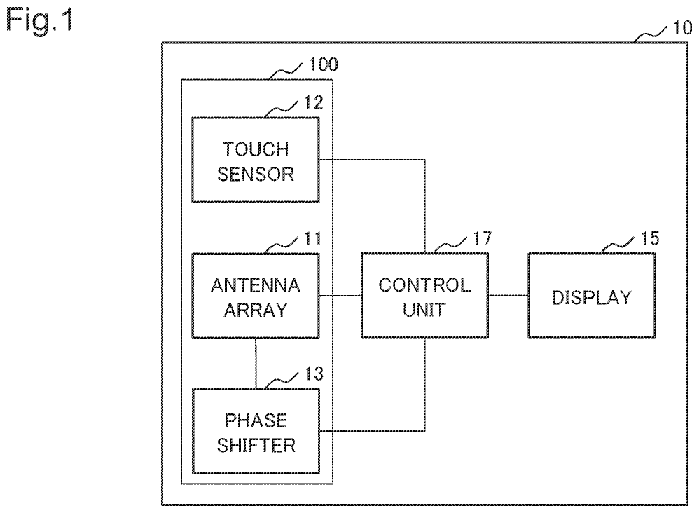

FIG. 1 is a block diagram illustrating an example of a configuration of a display antenna 10 according to the present disclosure. The display antenna 10 includes an antenna array 11, a touch sensor 12, a phase shifter 13, a display 15, and a control unit 17. The antenna array 11, the touch sensor 12, and the phase shifter 13 constitute an antenna device 100. The control unit 17 may be added to the antenna device 100. The display antenna 10 has a structure in which the antenna device 100 overlaps the display 15. The control unit 17 may be disposed outside the display antenna 10. In this case, the display antenna 10 is configured by the antenna array 11, the touch sensor 12, the phase shifter 13, and the display 15.

The antenna array 11 includes a plurality of patch antennas. The patch antenna is a plate-shaped radiation element. For example, the patch antenna has a square shape. The patch antenna may have a rectangular shape or a rhombic shape. The patch antenna may have any shape other than the square shape, the rectangular shape, or the rhombic shape as long as it can receive radio waves in a wavelength band to be transmitted and received. The patch antenna is a transparent electrode that can transmit light in a wavelength band of a visible region. For example, the visible region is a wavelength band of 380 to 800 nm (nanometers). For example, the patch antenna is made of a material such as indium tin oxide, zinc oxide, tin oxide, or titanium oxide. The material forming the patch antenna is not limited as long as it can transmit light in the wavelength band of the visible region. The patch antenna may be made of a material that transmits light in a wavelength band that is not the visible region. For example, the patch antenna may be made of a material that transmits light in a near-infrared region, an infrared region, or an ultraviolet region.

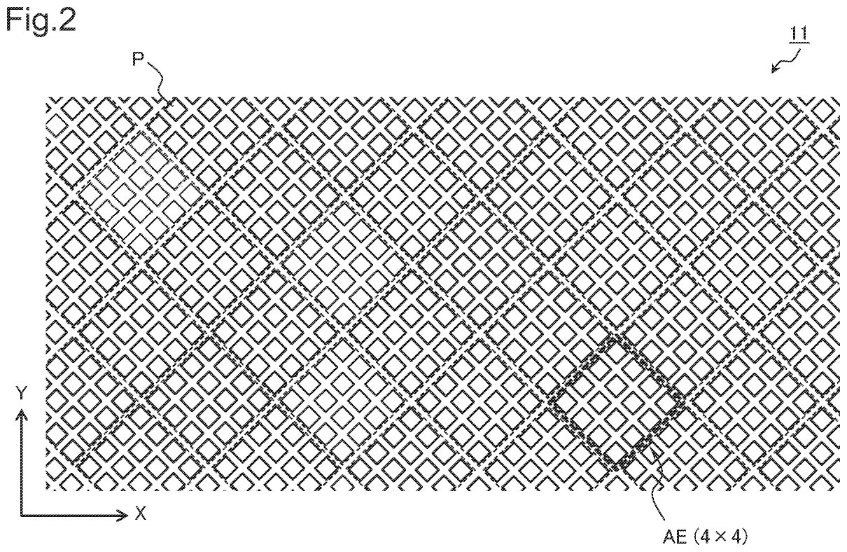

FIG. 2 is a conceptual diagram illustrating an example of a configuration of the antenna array according to the present disclosure. The antenna array 11 has a configuration in which a plurality of patch antennas P are arranged in a two-dimensional array. The patch antenna P resonates at a frequency that is an integral multiple of a wavelength that is half of a length associated to one side. The size of the patch antenna P is set according to the wavelength of the radio wave to be transmitted and received. In the example illustrated in FIG. 2, the patch antenna P has a square shape. The plurality of patch antennas P form a pattern (diamond pattern) in which the patch antennas P are arranged in a state of being rotated by 45 degrees about an intersection of diagonal lines of a square forming an outer shape of the patch antenna P as a rotation center. That is, the plurality of patch antennas P are arranged in a diamond pattern. The plurality of patch antennas P may be arranged in a pattern other than the diamond pattern as long as they can have the functions of the phased array antenna.

The plurality of patch antennas P are arranged in a two-dimensional array. In the example illustrated in FIG. 2, the plurality of patch antennas P are arranged in a two-dimensional array along an X direction and a Y direction. The plurality of patch antennas P are grouped in units of several patch antennas P. In the example illustrated in FIG. 2, an antenna assembly AE in which 4×4 patch antennas are arranged is configured by a group of 16 patch antennas P as a unit. In the display antenna 10 according to the present example embodiment, the number or combination of patch antennas P constituting the antenna assembly AE can be changed in any manner, which will be described below. For example, the antenna assembly AE may be formed in a region of 6.8 mm (millimeter) square in order to transmit and receive radio waves in a frequency band of 70 GHz (gigahertz).

The optimum size of the patch antenna P used in the frequency band associated to mobile communication after the fifth generation mobile communication system (5G) is determined according to the wavelength λ of the radio waves to be transmitted and received. For the wavelength λ in a space of the radio waves to be transmitted and received, when the interval (pitch) between adjacent patch antennas P is larger than 0.7λ, side lobes are large, and the gain is reduced. As the pitch between the adjacent patch antennas P is larger, a scanning angle is narrower. Therefore, the pitch between the adjacent patch antennas P is preferably about 0.4 to 0.5λ. In the present example embodiment, the number or combination of patch antennas P constituting the antenna assembly AE is changed depending on the wavelength of the radio waves to be transmitted and received to respond to the transmission and reception of the radio waves in a plurality of wavelength bands.

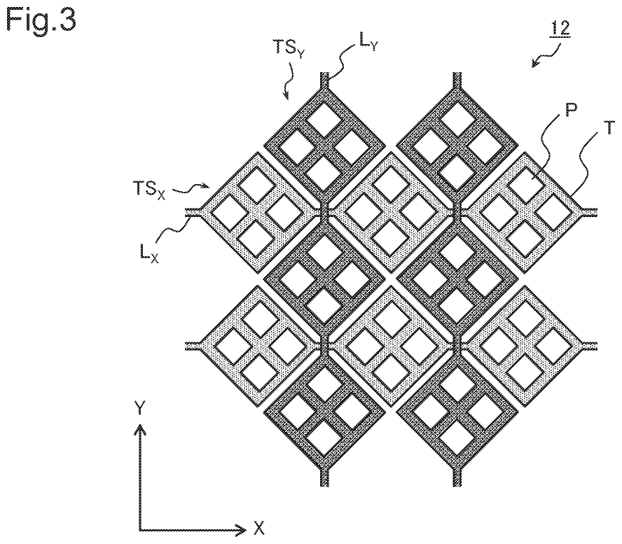

A touch electrode T also serves as a ground electrode of the patch antenna P. The touch electrode T is grounded through a circuit (not illustrated). The plurality of touch electrodes T are arranged in a two-dimensional array. FIG. 3 is a conceptual diagram illustrating an example of the touch sensor according to the present disclosure. FIG. 3 is a plan view seen from the patch antennas P. Four patch antennas P are disposed above one touch electrode T. Two touch electrodes T that are adjacent in a row direction (X direction) are connected by a wire L_{X}. A row sensor TS_{X} that is configured by a plurality of touch electrodes T connected in the row direction (X direction) is used for position detection in the row direction (X direction). Two touch electrodes T that are adjacent in a column direction (Y direction) are connected by a wire L_{Y}. A column sensor TS_{Y} that is configured by a plurality of touch electrodes T connected in the column direction (Y direction) is used for position detection in the column direction (Y direction). A contact position is detected according to a change in capacitance at an intersection of a row that is configured by a plurality of touch electrodes T connected in the X direction and a column that is configured by a plurality of touch electrodes T connected in the Y direction.

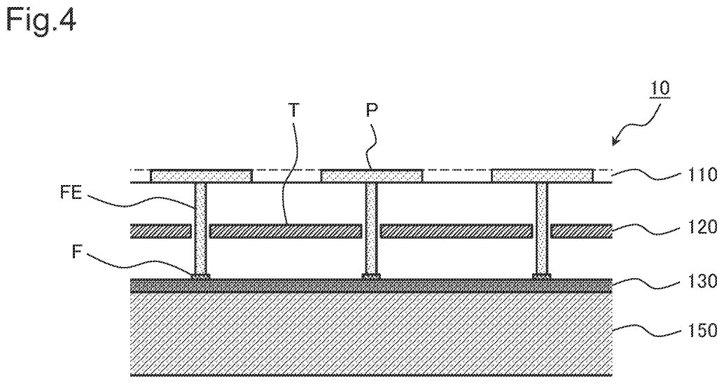

FIG. 4 is a cross-sectional view illustrating an example of a structure of the display antenna according to the present disclosure. FIG. 4 illustrates a portion of the configuration of the display antenna 10. FIG. 4 illustrates an antenna layer 110, a touch sensor layer 120, a phase shifter forming layer 130, and a display forming layer 150. The display 15 is configured in the display forming layer 150. The phase shifter forming layer 130 including the phase shifter 13 is disposed above the display forming layer 150. The touch sensor layer 120 configured by the touch electrodes T that also serve as the ground electrodes is disposed above the phase shifter forming layer 130. The antenna layer 110 configured by a plurality of patch antennas P is disposed above the touch sensor layer 120. Each of the plurality of patch antennas P is connected to a feeding point F of the phase shifter 13 included in the phase shifter forming layer 130 through a feeding electrode FE. The feeding electrode FE electrically connects the patch antenna P and the phase shifter 23 through a through hole that is formed in the touch sensor layer 120.

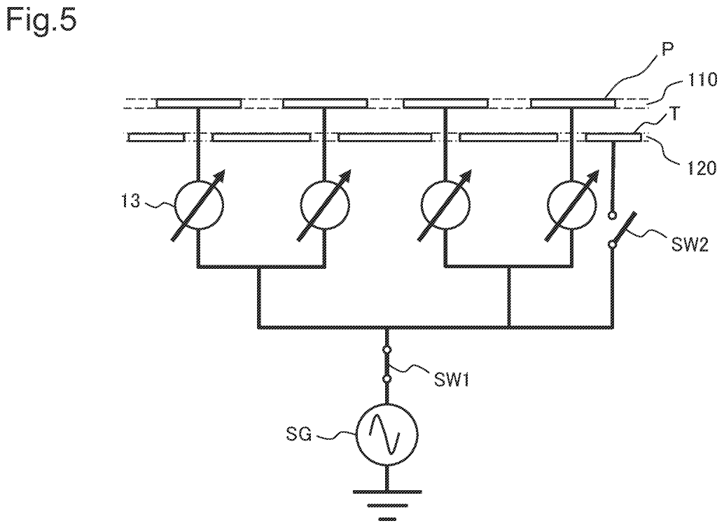

FIGS. 5 to 7 are conceptual diagrams illustrating an example of switching between the patch antenna and the touch electrode according to the present disclosure. The plurality of touch electrodes T constituting the antenna layer 110 are set to the same potential through wires (not illustrated). Each of the plurality of patch antennas P is connected to the feeding point of the phase shifter 13 through the through hole that is formed in the touch sensor layer 120 configured by the plurality of touch electrodes T. An input end of the phase shifter 13 is connected to one end of a switch SW1. The other end of the switch SW1 is connected to a signal source SG. That is, the phase shifter 13 is connected to the signal source SG through the switch SW1. At least one of the plurality of touch electrodes T constituting the touch sensor layer 120 is connected to one end of a switch SW2. The other end of the switch SW2 is connected to the one end of the switch SW1 and the input end of the phase shifter 13. That is, the plurality of touch electrodes T constituting the touch sensor layer 120 are connected to the switch SW1 and the phase shifters 13 through the switch SW2. The control unit 17 turns on and off the switch SW1 and the switch SW2 in accordance with the scanning of the touch electrode T constituting the touch sensor.

The control unit 17 turns on the switch SW1 that is connected to the patch antenna P located above the touch electrode T that is not being scanned. FIG. 5 illustrates that the switch SW1 is in an on state (ON) and the switch SW2 is in an off state (OFF). In the state illustrated in FIG. 5, the input ends of the plurality of phase shifters 13 are connected to the signal source SG. According to high-frequency power supplied from the signal source SG to the patch antenna P, a signal to be transmitted that has been supplied through a signal line (not illustrated) is transmitted as a radio signal from the patch antenna P.

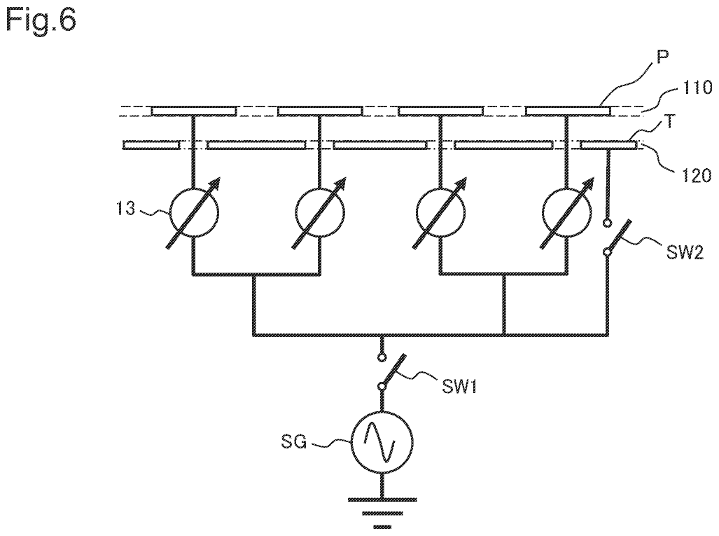

The control unit 17 turns off the switch SW1 that is connected to the patch antenna P located above the touch electrode T that is being scanned. FIG. 6 illustrates that the switch SW1 is in an off state (OFF) and the switch SW2 is also in an off state (OFF). In the state illustrated in FIG. 6, the input ends of the plurality of phase shifters 13 are disconnected from the signal source SG. Therefore, the high-frequency power is not supplied from the signal source SG to the patch antenna P, and the radio signal is not transmitted from the patch antenna P. The control unit 17 detects the contact position in accordance with a change in capacitance at the touch electrode T that is being scanned.

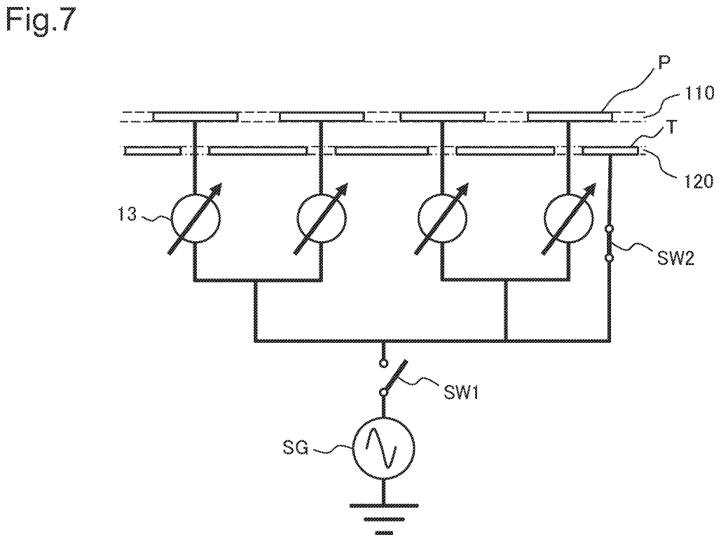

The control unit 17 may turn on the switch SW2 connected to the touch electrode T that is being scanned in accordance with the detection of contact at the touch electrode T that is being scanned. FIG. 7 illustrates that the switch SW1 is in an off state (OFF) and the switch SW2 is in an on state (ON). In the state illustrated in FIG. 7, the input ends of the plurality of phase shifters 13 are disconnected from the signal source SG, and the patch antenna P and the touch electrode T have the same potential. As a result, the patch antenna P and the touch electrode T having the same potential function as the touch sensor. Since the number of electrodes constituting the touch sensors in the state illustrated in FIG. 7 is larger than that in the state illustrated in FIG. 6, the sensitivity of contact detection is improved.

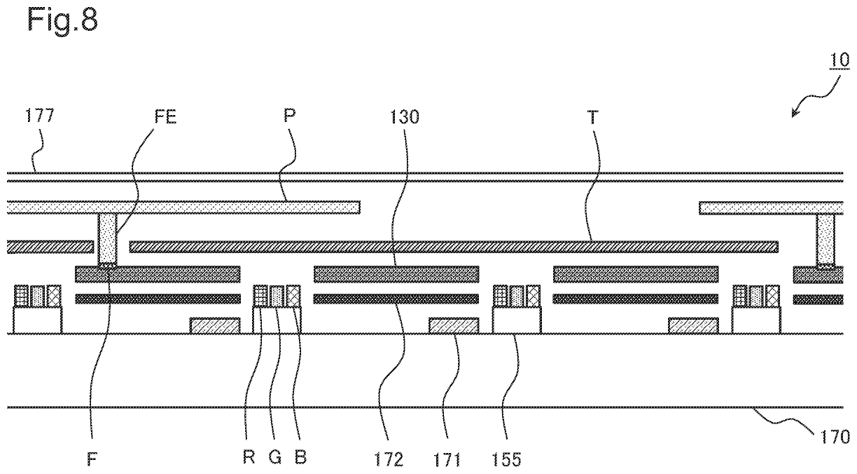

FIG. 8 is a cross-sectional view illustrating an example of the structure of the display antenna according to the present disclosure. In the cross-sectional view of FIG. 8, the hatching of some portions is omitted. FIG. 8 illustrates the patch antenna P, the touch electrode T, the feeding electrode FE, and the feeding point F. FIG. 8 illustrates the phase shifter forming layer 130, a light emitter 155, a substrate 170, a wiring layer 171, a shield electrode 172, and a protective layer 177.

The display 15 is formed on the substrate 170 by a plurality of light emitters 155. The plurality of light emitters 155 are arranged in a two-dimensional array. For example, the light emitter 155 has a light emitting unit that emits light in a wavelength band associated to each of red (R), green (G), and blue (B). For example, the light emitter 155 is implemented by a micro light-emitting diode (LED). The micro LED includes a red LED that emits light in a wavelength band of red R, a green LED that emits light in a wavelength band of green G, and a blue LED that emits light in a wavelength band of blue B. When light of three primary colors of red R, green G, and blue B can be emitted, various colors can be expressed by mixing these light components. The light emitter 155 may include at least one of the red LED, the green LED, and the blue LED. The light emitter 155 may include a light emitting unit that emits light in a wavelength band different from those of the red LED, the green LED, and the blue LED. The light emitter 155 is connected to a driving unit (not illustrated) through wires included in the wiring layer 171. The light emitter 155 causes the red LED, the green LED, and the blue LED to emit light in accordance with the control of the driving unit by the control unit 17.

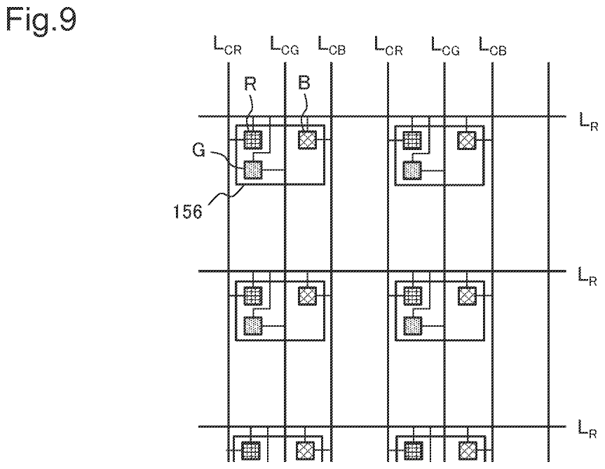

FIG. 9 is a conceptual diagram illustrating an example of a configuration of the light emitter according to the present disclosure. FIG. 9 illustrates an aspect in which light emitters 156 are arranged in a two-dimensional array. FIG. 9 illustrates a portion of the display 15 configured by a plurality of light emitters 156. The light emitter 156 includes a red LED (R), a green LED (G), and a blue LED (B). The red LED, the green LED, and the blue LED are micro LEDs. The red LED, the green LED, and the blue LED are collectively disposed in one place. A row selection line L_{R} and a column selection line LCR are connected to the red LED. The row selection line L_{R} and a column selection line L_{CG} are connected to the green LED. The row selection line L_{R} and a column selection line L_{CB} are connected to the blue LED. The row selection line L_{R} is a selection line common to the red LED, the green LED, and the blue LED. With the selection of the row selection line L_{R} and the column selection line LCR, the red LED at the position where the two selected selection lines intersect with each other emits light. With the selection of the row selection line L_{R} and the column selection line L_{CG}, the green LED at the position where the two selected selection lines intersect with each other emits light. With the selection of the row selection line L_{R} and the column selection line L_{CB}, the blue LED at the position where the two selected selection lines intersect with each other emits light.

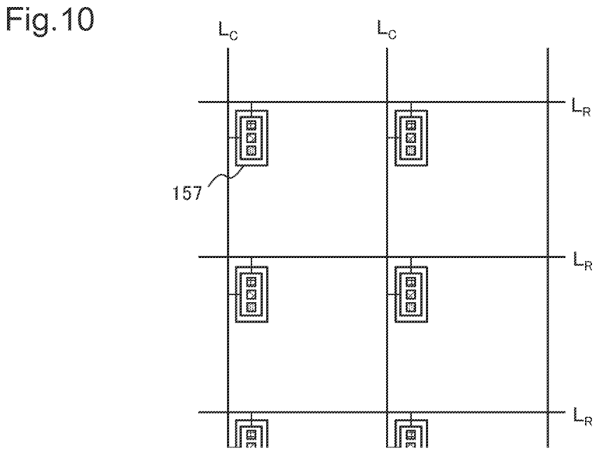

FIG. 10 is a conceptual diagram illustrating another example of the configuration of the light emitter according to the present disclosure. FIG. 10 illustrates an aspect in which light emitters 157 are arranged in a two-dimensional array. FIG. 10 illustrates a portion of the display 15 configured by a plurality of light emitters 157. The light emitter 157 is an integrated micro LED in which red, green, and blue light emitting units are integrated. A red LED, a green LED, and a blue LED are connected to a common row selection line L_{R} and a common column selection line L_{C}. With the selection of the row selection line L_{R} and the column selection line L_{C}, at least one of the red LED, the green LED, and the blue LED at the position where the two selected selection lines intersect each other emits light.

A plurality of light emitters 155 constituting the display 15 emit light under the control of the control unit 17. A region between the plurality of light emitters 155 is referred to as a gap region. The gap region includes an upper region between the plurality of light emitters 155. For example, an insulating layer is formed between the plurality of light emitters 155 and the wiring layer 171. A material forming the insulating layer is not particularly limited. For example, a gap may be formed between the plurality of light emitters 155 and the wiring layer 171. A desired image is displayed on the display 15. For example, an image of a touch panel including at least one input image is displayed on the display 15. For example, the input image is a button for receiving an operation. For example, the input image is an image of keys for receiving the input of characters, numbers, and symbols, such as a keyboard or a numeric keypad. For example, the input image is an image that receives an operation, such as a slider or a tag. When contact is detected at the position of the input image displayed on the display 15 by the patch antenna P functioning as the touch sensor, an input associated to the operation detected at the position of the input image is performed.

The wiring layer 171 is formed on an upper surface of the substrate 170 (FIG. 8). The wiring layer 171 is formed between the plurality of light emitters 155. Wires for driving the display 15 are disposed in the wiring layer 171. Various switches and wires may be disposed in the wiring layer 171. A signal line through which a signal to be transmitted and received is propagated may be disposed in the wiring layer 171. The wiring layer 171 may be a single layer or may have a stacked structure of a plurality of layers. For example, when a device transfer technique is used, it is possible to form a minute element in the wiring layer 171. The drawings for details of components in the wiring layer 171, a connection relationship between the components, and the like are omitted.

A planarizing film or a protective film is formed in an upper portion of the display 15 configured by the plurality of light emitters 155. The planarizing film or the protective film is made of a transparent material that can transmit light in the wavelength band of the visible region. The material forming the planarizing film or the protective film is not limited as long as it can transmit light in the wavelength band of the visible region. For example, the planarizing film or the protective film is made of silicon oxide or the like. A gap may be formed in the upper portion of the display 15.

The shield electrode 172 is disposed above the wiring layer 171. The shield electrode 172 is disposed to avoid a region above the light emitter 155. The shield electrode 172 is formed to prevent electromagnetic coupling between the upper side and lower side of the shield electrode 172. The shield electrode 172 has conductivity. A material forming the shield electrode 172 is not particularly limited as long as it has conductivity. For example, the shield electrode 172 is made of a material including metal such as aluminum or copper. The shield electrode 172 is connected to a housing or a ground terminal by a conductive wire (not illustrated) or the like. The shield electrode 172 has the same potential as a ground point to which the shield electrode 172 is connected. Capacitance corresponding to a dielectric constant of a dielectric layer or a space formed between the patch antenna P, the wiring layer 171, or the phase shifter forming layer 130 and the shield electrode 172 is formed therebetween.

The phase shifter forming layer 130 is disposed above the shield electrode 172. The phase shifter forming layer 130 is configured by the phase shifters 13. The phase shifter 13 is disposed at a position that avoids the upper side of the light emitter 155. The feeding point F of the phase shifter 13 is connected to the patch antenna P through the feeding electrode FE. Various switches, wires, and the like may be disposed in the phase shifter forming layer 130. A signal line (not illustrated) through which the signal to be transmitted and received is propagated may be disposed in the phase shifter forming layer 130. The phase shifter forming layer 130 may be a single layer or may have a stacked structure of a plurality of layers. For example, when the device transfer technique is used, it is possible to form a minute element in the phase shifter forming layer 130. The drawings for details of components in the phase shifter forming layer 130, a connection relationship between the components, and the like are omitted.

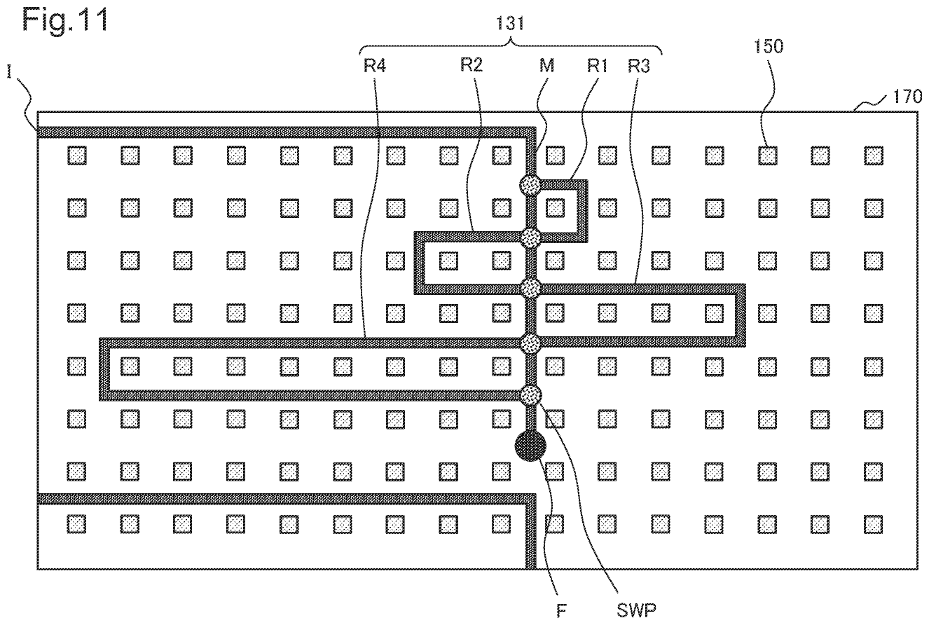

FIG. 11 illustrates an example of the phase shifter that is disposed in the phase shifter forming layer according to the present disclosure. FIG. 11 is a plan view illustrating the upper surface of the substrate 170 as viewed from above. A phase shifter 131 is disposed between a plurality of light emitters 155 in a top view. The phase shifter 131 is an example of a line switching phase shifter. The phase shifter 131 has a configuration in which branch lines (R1, R2, R3, and R4) having different line lengths are connected to a main line M through phase shift switches SWP. In the example illustrated in FIG. 11, four branch lines (R1, R2, R3, and R4) are connected to the main line M that connects an input end I and the feeding point F. The phase of a signal that has passed through the phase shifter 131 is shifted by a phase shift amount corresponding to connection states between the main line M and the branch lines (R1, R2, R3, and R4). The connections between the main line M and the branch lines (R1, R2, R3, and R4) are switched according to the turn-on and turn-off control of the phase shift switches SWP by the control unit 17.

The branch line R1 is a line that gives a phase difference of 22.5 degrees. The phase of the signal that has passed through the branch line R1 is shifted by 22.5 degrees with respect to the phase of a signal that has traveled through the main line M without passing through the branch line R1. The branch line R2 is a line that gives a phase difference of 45 degrees. The phase of the signal that has passed through the branch line R2 is shifted by 45 degrees with respect to the phase of the signal that has traveled through the main line M without passing through the branch line R2. The branch line R3 is a line that gives a phase difference of 90 degrees. The phase of the signal that has passed through the branch line R3 is shifted by 90 degrees with respect to the phase of the signal that has traveled through the main line M without passing through the branch line R3. The branch line R4 is a line that gives a phase difference of 180 degrees. The phase of the signal that has passed through the branch line R4 is shifted by 180 degrees with respect to the phase of the signal that has traveled through the main line M without passing through the branch line R4. For example, the phase of the signal that has passed through the branch line R1 and the branch line R2 is shifted by 47.5 degrees with respect to the phase of the signal that has traveled through the main line M without passing through these lines.

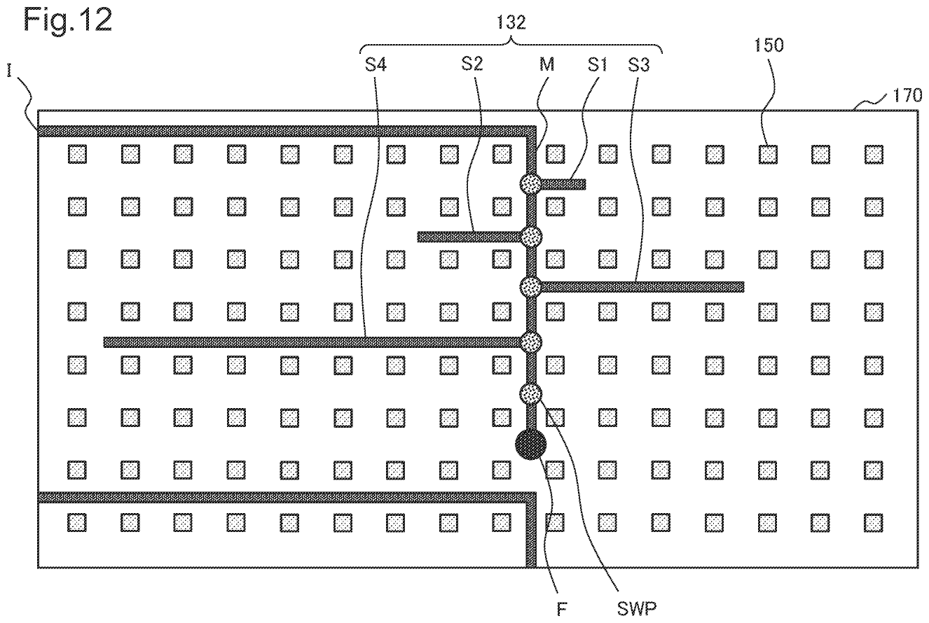

FIG. 12 illustrates an example of the phase shifter disposed in the phase shifter forming layer according to the present disclosure. FIG. 12 is a plan view illustrating the upper surface of the substrate 170 as viewed from above. A phase shifter 132 is disposed between a plurality of light emitters 155 in a top view. The phase shifter 132 is an example of a stub switching phase shifter. The phase shifter 132 has a configuration in which open stubs (S1, S2, S3, and S4) having different line lengths are connected to the main line M through the phase shift switches SWP. In the example illustrated in FIG. 12, four open stubs (S1, S2, S3, and S4) are connected to the main line M that connects the input end I to the feeding point F. The phase of a signal that has passed through the phase shifter 132 is shifted by a phase shift amount corresponding to connection states between the main line M and the open stubs (S1, S2, S3, and S4). The connections between the main line M and the open stubs (S1, S2, S3, and S4) are switched according to the turn-on and turn-off control of the phase shift switches SWP by the control unit 17.

The open stub S1 is a stub that gives a phase difference of 22.5 degrees. The phase of the signal that has passed through the open stub S1 is shifted by 22.5 degrees with respect to the phase of the signal that has traveled through the main line M without passing through the open stub S1. The open stub S2 is a stub that gives a phase difference of 45 degrees. The phase of the signal that has passed through the open stub S2 is shifted by 45 degrees with respect to the phase of the signal that has traveled through the main line M without passing through the open stub S2. The open stub S3 is a stub that gives a phase difference of 90 degrees. The phase of the signal that has passed through the open stub S3 is shifted by 90 degrees with respect to the phase of the signal that has traveled through the main line M without passing through the open stub S3. The open stub S4 is a stub that gives a phase difference of 180 degrees. The phase of the signal that has passed through the open stub S4 is shifted by 180 degrees with respect to the phase of the signal that has traveled through the main line M without passing through the open stub S4. For example, the phase of the signal that has passed through the open stub S1 and the open stub S2 is shifted by 47.5 degrees with respect to the phase of the signal that has traveled through the main line M without passing through these stubs.

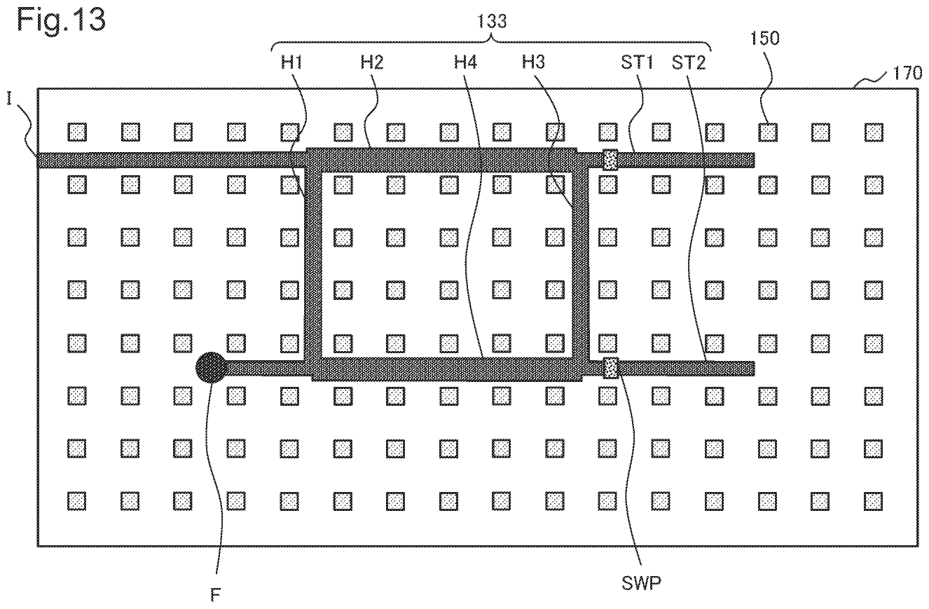

FIG. 13 illustrates an example of the phase shifter disposed in the phase shifter forming layer according to the present disclosure. FIG. 13 is a plan view illustrating the upper surface of the substrate 170 as viewed from above. A phase shifter 133 is disposed between a plurality of light emitters 155 in a top view. The phase shifter 133 is an example of a reflective phase shifter. The phase shifter 133 has a configuration in which a 90-degree hybrid circuit and a stub are combined. A transmission line H1, a transmission line H2, a transmission line H3, and a transmission line H4 constitute the 90-degree hybrid circuit. The electrical length of the transmission line H1, the transmission line H2, the transmission line H3, and the transmission line H4 constituting the 90-degree hybrid circuit is λ/4 (90 degrees). The characteristic impedance of the transmission line H1 and the transmission line H3 is Z₀. The characteristic impedance of the transmission line H2 and the transmission line H4 is Z₀/√2.

The phase shifter 133 includes a stub ST1 and a stub ST2. In the example illustrated in FIG. 13, the stub ST1 and the stub ST2 are open stubs having an open end (right end). The stub ST1 and the stub ST2 may be short stubs whose open ends (right ends) are grounded. The lengths of the stub ST1 and the stub ST2 can be set to any values. The phases of signals propagated through the stub ST1 and the stub ST2 are shifted by a phase difference corresponding to the lengths of the stub ST1 and the stub ST2. The lengths of the stub ST1 and the stub ST2 may be variable. For example, when switches are disposed on lines of the stub ST1 and the stub ST2, the switches can be turned on and off to change the lengths of the stub ST1 and the stub ST2.

A first end (upper end) of the transmission line H1 is connected to the input end I. The first end (upper end) of the transmission line H1 is connected to a first end (left end) of the transmission line H2. A second end (lower end) of the transmission line H1 is connected to the feeding point F. The second end (lower end) of the transmission line H1 is connected to a first end (left end) of the transmission line H4. The first end (left end) of the transmission line H2 is connected to the input end I. The first end (left end) of the transmission line H2 is connected to the first end (upper end) of the transmission line H1. A second end (right end) of the transmission line H2 is connected to the stub ST1 through the phase shift switch SWP. The second end (right end) of the transmission line H2 is connected to a first end (upper end) of the transmission line H3. The first end (upper end) of the transmission line H3 is connected to the second end (right end) of the transmission line H2. The first end (upper end) of the transmission line H3 is connected to the stub ST1 through the phase shift switch SWP. A second end (lower end) of the transmission line H3 is connected to the stub ST2 through the phase shift switch SWP. The second end (lower end) of the transmission line H3 is connected to a second end (right end) of the transmission line H4. The first end (left end) of the transmission line H4 is connected to the feeding point F. The first end (left end) of the transmission line H4 is connected to the second end (lower end) of the transmission line H1. The second end (right end) of the transmission line H4 is connected to the second end (lower end) of the transmission line H3. The second end (right end) of the transmission line H4 is connected to the stub ST2 through the phase shift switch SWP. The phase of the signal that has passed through the phase shifter 13 is shifted by a phase shift amount corresponding to the electrical length of the line or the stub through which the signal has passed, according to the turn-on and turn-off states of the switch SW. The phase shift amount of the phase shifter 13 is switched according to the turn-on and turn-off control of the phase shift switch SWP by the control unit 17.

The touch sensor layer 120 configured by a plurality of touch electrodes T is disposed above the display 15 configured by a plurality of light emitters 155 and the phase shifter forming layer 130. The plurality of touch electrodes T also serve as ground electrodes. That is, the touch sensor layer 120 functions as a shield layer. The touch electrode T is configured by a transparent conductor. For example, similarly to the patch antenna P, the touch electrode T is made of a material such as indium tin oxide, zinc oxide, tin oxide, or titanium oxide. The material forming the touch electrode T is not limited as long as it can transmit light in the wavelength band of the visible region. The touch electrode T is connected to the housing or the ground terminal by a conductive wire (not illustrated) or the like. The potential of the touch electrode T is the same as the ground point to which the touch electrode T is connected. Capacitance corresponding to a dielectric constant of a dielectric layer or a space formed between the patch antenna P or the phase shifter 13 or the wire formed in the phase shifter forming layer 130 and the touch electrode T is formed therebetween.

The antenna layer 110 configured by a plurality of patch antennas P is disposed above the touch sensor layer 120 in which the touch electrodes T are formed. The plurality of patch antennas P are electrically connected to the feeding points F of the phase shifters 13 formed in the phase shifter forming layer 130 through the feeding electrodes FE. The feeding electrode FE is a conductive via that electrically connects the patch antenna P and the feeding point of the phase shifter 13. A material forming the feeding electrode FE is not particularly limited as long as it has conductivity.

The protective layer 177 is formed above the plurality of patch antennas P. The protective layer 177 is made of a member that can transmit light in the wavelength band of the visible region. A material forming the protective layer 177 is not limited as long as it can transmit light in the wavelength band of the visible region. For example, the protective layer 177 is made of a transparent member such as glass or plastic.

A dielectric layer (not illustrated) is formed in a space between the wiring layer 171 and the protective layer 177. The dielectric layer is made of a dielectric that can transmit light in the wavelength band of the visible region. The space between the wiring layer 171 and the protective layer 177 may be filled with the dielectric forming the dielectric layer, or a gap may be formed therebetween. The material, shape, and position of the dielectric layer are not particularly limited.

A signal to be transmitted is output from a transmission circuit (not illustrated). The signal output from the transmission circuit reaches the phase shifter 13 through a signal line (not illustrated). The phase of the signal to be transmitted that has reached the phase shifter 13 is shifted by a phase shift amount set in the phase shifter 13. The signal that has passed through the phase shifter 13 reaches the patch antenna P through the feeding electrode FE. The signal that has reached the patch antenna P is transmitted as the radio wave in the wavelength band to be transmitted. The transmission direction of the radio wave transmitted from the display antenna 10 is controlled for each antenna assembly AE.

The phase of the radio wave to be received that has been received by the patch antenna P is shifted by the phase shift amount set in the phase shifter 13 that is connected to the patch antenna P. The signal whose phase has been shifted is received by a receiving circuit (not illustrated) through a signal line. Information included in the signal received by the receiving circuit is decoded by a decoder (not illustrated).

The control unit 17 (control unit) controls the connection states of the plurality of patch antennas P constituting the antenna array 11 to form the antenna assembly AE. The control unit 17 sets the size of the antenna assembly AE in accordance with the frequency band of the radio waves to be transmitted and received. The control unit 17 switches between the on and off states of the switch (not illustrated) disposed between the patch antennas P to change a combination of the patch antennas P constituting the antenna assembly AE. As a result, the size of the antenna assembly AE is set in accordance with the frequency band of the radio waves to be transmitted and received. The control unit 17 grounds the touch electrodes T disposed below the patch antennas P set as the antenna assembly AE. The touch electrode T disposed below the patch antenna P functions as the ground electrode of the patch antenna P.

For example, in a case where the frequency band of the radio waves to be transmitted and received is 70 GHz, the control unit 17 sets the size of the antenna assembly AE in such a way that the antenna assembly AE is a square region with one side of 6.8 mm. The control unit 17 turns on and off a plurality of switches to combine 16 (4×4) patch antennas P each of which has one side of 1.7 mm. The control unit 17 turns on and off the plurality of switches in such a way that the 16 patch antennas P have the same potential. As a result, 16 patch antennas P that are arranged in a 4×4 matrix are combined to set the antenna assembly AE that is a square region having one side of 6.8 mm. The control unit 17 sets a plurality of antenna assemblies AE in the antenna array 11. The control unit 17 sets a switch used for the connection between adjacent antenna assemblies AE to an off state. In a case where a plurality of antenna assemblies AE are combined to form a larger antenna assembly AE, the control unit 17 sets the switch used for the connection between adjacent antenna assemblies AE to an on state. In this case, the control unit 17 sets the switch used for the connection between adjacent antenna assemblies AE to the on state in accordance with the wavelength band of the radio waves to be transmitted and received.

The control unit 17 sets the phase shift amount of the phase shifter 13. The control unit 17 switches between the on and off states of the phase shift switch SWP disposed in the phase shifter 13 to set the phase shift amount of the phase shifter 13. The control unit 17 supplies the signal, that is to be transmitted, to the signal line connected to the input end I of the phase shifter 13 whose phase shift amount has been set. The control unit 17 turns on the switch (not illustrated) that switches the connection between the signal source (not illustrated) and the patch antennas P constituting the antenna assembly AE used for transmitting the radio waves. The signal source is a high-frequency power source that is used for transmitting the radio waves to be transmitted. The signal source supplies high-frequency power corresponding to the frequency band of the radio waves to be transmitted or the transmission strength of the radio waves. The high-frequency power is supplied from the signal source to the antenna assembly AE including the patch antennas P connected to the signal source. As a result, the phase of the signal to be transmitted that has been supplied from the signal line is shifted according to the phase shift amount of the phase shifter 13, and the signal is transmitted from the antenna assembly AE.

The control unit 17 sequentially switches the active row sensor TS_{X} and column sensor TS_{Y} to scan contact. The row sensor TS_{X} detects contact in the row direction (X direction). The column sensor TS_{Y} detects contact in the column direction (Y direction). The control unit 17 sequentially turns off the switches SW1 connected to the patch antennas P located above the touch electrodes T that are being scanned to disconnect the patch antennas P from the signal source SG. As a result, the supply of the high-frequency power to the patch antennas P is stopped in accordance with the scanning of contact detection. The control unit 17 detects the contact position according to a change in capacitance at an intersection of the row sensor TS_{X} and the column sensor TS_{Y}.

The control unit 17 controls display on the display 15. The control unit 17 causes the plurality of light emitters 155 constituting the display 15 to emit light in such a way that a user interface for receiving the input of an operation is displayed. The control unit 17 causes the plurality of light emitters 155 to emit light in such a way that display information for performing selection or operation is displayed at the detection position by the touch sensor 12 in association with the detection position. In a case where the user interface is not displayed, the control unit 17 may cause the plurality of light emitters 155 constituting the display 15 to emit light in such a way that an image that is not related to the touch panel is displayed. A display control unit (not illustrated) different from the control unit 17 may be used for display control of the display 15.

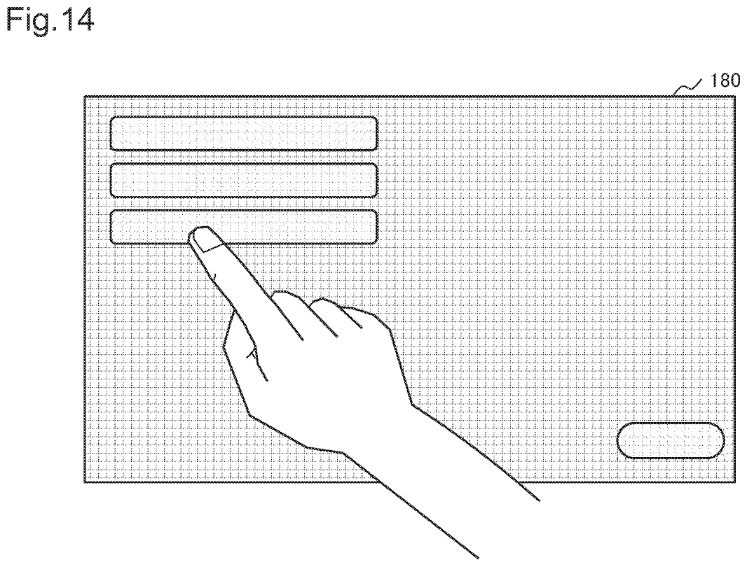

FIG. 14 is a conceptual diagram illustrating an example of a terminal device provided with the display antenna according to the present disclosure. An image of the display 15 included in the display antenna 10 is displayed on a screen 180 of the terminal device. The functions of the touch panel of the display antenna 10 are set on the screen 180 of the terminal device. FIG. 14 illustrates an example in which the user interface is displayed on the screen 180. FIG. 14 illustrates an aspect in which one of buttons included in the user interface displayed on the screen 180 is selected by the user. In FIG. 14, images of the touch sensors constituting the touch panel in the row direction and the column direction are illustrated in a mesh pattern. However, the size and interval of the touch sensors to be actually formed are not accurately illustrated.

In the example illustrated in FIG. 14, the display antenna 10 detects a position touched by a user's finger. The display antenna 10 receives an input associated to display information displayed at the detected position. The screen 180 of the terminal device also functions as a phased array antenna. As described above, the display antenna 10 can simultaneously exhibit the functions of the touch panel and the functions of the phased array antenna. The display antenna 10 may exhibit the functions of at least one of the touch panel, the phased array antenna, and the display.

### Modification Examples

Next, modification examples of the display antenna 10 according to the present example embodiment will be described. Here, four modification examples will be described. In the following description of the modification examples, a description of portions similar to those of the display antenna 10 described above will be omitted.

### Modification Example 1

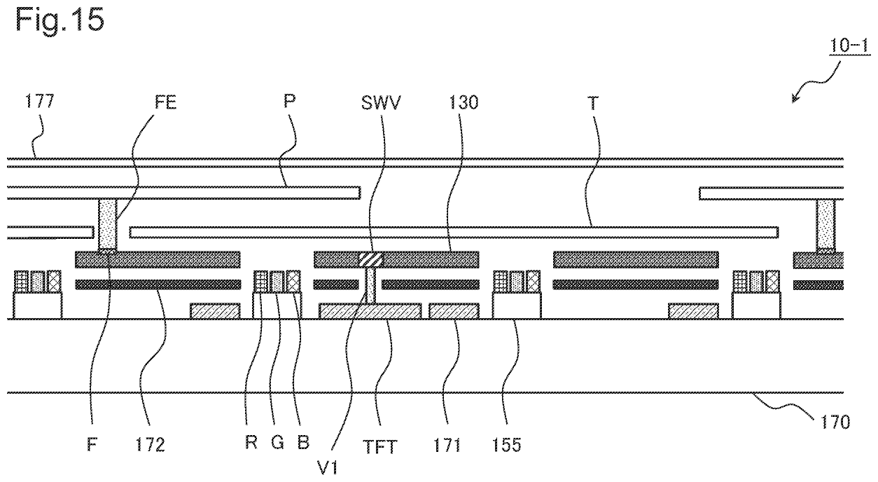

FIG. 15 is a conceptual diagram illustrating an example of a configuration of a display antenna 10-1 according to Modification Example 1. FIG. 15 illustrates an example of a cross-sectional structure of the display antenna 10-1. The display antenna 10-1 is an example of a configuration that implements the phase shift switch SWP included in the phase shifter 13 disposed in the phase shifter forming layer 130. In this modification example, an example will be described in which a switch SWV using the metal-insulator phase transition (hereinafter, referred to as phase transition) of vanadium dioxide VO₂ is used as the phase shift switch SWP.

The switch SWV is installed in the phase shifter 13. A thin film transistor (TFT) is disposed below the switch SWV with the shield electrode 172 interposed therebetween. The TFT is disposed on the upper surface of the substrate 170. A through hole is formed in the shield electrode 172. The through hole is formed below the switch SWV A via V1 is disposed through the through hole. The switch SWV is connected to the TFT that controls the turn-on and turn-off of the switch SWV through the via V1.

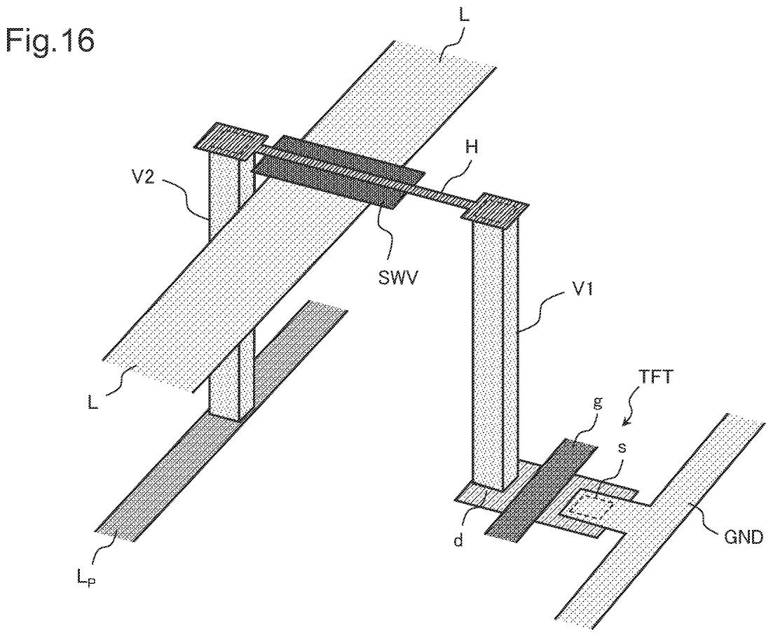

FIG. 16 is a conceptual diagram illustrating an example of a configuration for implementing the switch SWV The switch SWV illustrated in FIG. 16 includes a thin film of vanadium dioxide VO₂. When the temperature of the vanadium dioxide VO₂ is increased from room temperature, the electrical resistance of the vanadium dioxide VO₂ rapidly decreases in the vicinity of 67 degrees Celsius, and the vanadium dioxide VO₂ undergoes a phase transition from an insulator to metal. The vanadium dioxide VO₂ is an insulating phase at a temperature lower than a phase transition temperature. The vanadium dioxide VO₂ is a metal phase at a temperature higher than the phase transition temperature. In the actual phase transition of the vanadium dioxide VO₂, hysteresis occurs when the temperature rises and falls. Therefore, the temperature of the switch SWV is designed in such a way that the switch SWV is turned on and off in a predetermined temperature zone.

In the example illustrated in FIG. 16, the switch SWV is disposed in a wire L that is included in the phase shifter 13. For example, the switch SWV is disposed at a connection point between a branch line, a stub, or the like and a main line. An electric heating wire H is thermally connected to the switch SWV. A first end of an electric heating wire H is electrically connected to a power supply line L_{P} through a via V2. A second end of the electric heating wire H is electrically connected to a drain d of the TFT through the via V1. The electric heating wire H is used to control the temperature of the thin film of the vanadium dioxide VO₂ included in the switch SWV. For example, the electric heating wire H is made of an alloy including nickel Ni or chromium Cr as a main component. The electric heating wire H may be made of an alloy including chromium Cr, iron Fe, and aluminum A1 as main components. A material forming the electric heating wire H is not particularly limited as long as it is a material whose temperature is easily controlled in accordance with the application of a current.

The supply of the current to the electric heating wire H can be controlled using the TFT. When a voltage exceeding a threshold voltage is applied to a gate g of the TFT, the TFT is turned on. When the TFT is turned on, a source s is connected to a grounding line GND and the drain d have the same potential (0 V), and a current is supplied to the electric heating wire H through the power supply line L_{P}. When the current is supplied to the electric heating wire H, the temperature of the electric heating wire increases. The heat of the electric heating wire H is transferred to the thin film of the vanadium dioxide VO₂ included in the switch SWV. When the temperature of the thin film of the vanadium dioxide VO₂ included in the switch SWV exceeds the phase transition temperature, the thin film undergoes a phase transition to the metal phase. As a result, the switch SWV is turned on, and a current flows through the wire L in which the switch SWV is provided. When the supply of the current to the electric heating wire H is stopped, the temperature of electric heating wire H decreases. When the temperature of the thin film of the vanadium dioxide VO₂ included in the switch SWV falls below the phase transition temperature, the thin film undergoes a phase transition to the insulating phase. As a result, the switch SWV is turned off, and the wire L in which the switch SWV is provided is electrically disconnected.

According to this modification example, the use of the switch SWV including the thin film of the vanadium dioxide VO₂ makes it possible to collectively manufacture the display antenna 10-1 with a semiconductor process. According to this modification example, it is possible to reduce the size of the phase shifter 13 formed in the phase shifter forming layer 130. The switch SWV including the thin film of the vanadium dioxide VO₂ may be applied to other switches included in the display antenna 10-1.

### Modification Example 2

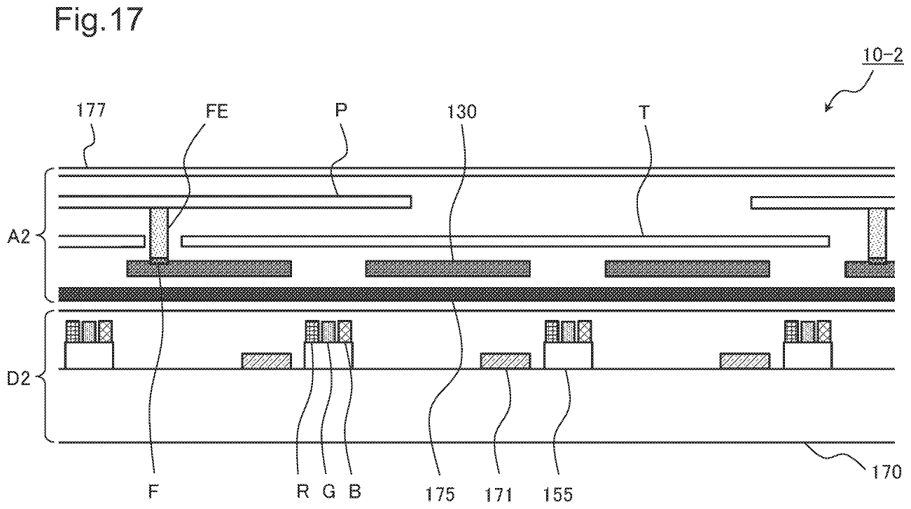

FIG. 17 is a conceptual diagram illustrating an example of a configuration of a display antenna 10-2 according to Modification Example 2. FIG. 17 illustrates an example of a cross-sectional structure of the display antenna 10-2. The display antenna 10-2 has a configuration in which an antenna function (antenna A2) and a display function (display D2) are separated. The antenna A2 is stacked on the display D2. The antenna A2 includes the patch antenna P, the touch electrode T, the feeding electrode FE, the phase shifter forming layer 130, a shield layer 175, and the protective layer 177. The display D2 includes a plurality of light emitters 155, the substrate 170, and the wiring layer 171. The functions of the antenna and the functions of the display may be integrally formed. In FIG. 17, a portion of the configuration of the display antenna 10-2 is omitted. In a cross-sectional view of FIG. 17, the hatching of some portions is omitted.

Instead of the shield electrode 172, the shield layer 175 is formed in the lowermost layer of the antenna A2. The shield layer 175 is formed to prevent electromagnetic coupling between the upper side and lower side of the shield layer 175. The shield layer 175 is made of a transparent conductor. For example, similarly to the patch antenna P, the shield layer 175 is made of a material such as indium tin oxide, zinc oxide, tin oxide, or titanium oxide. The material forming the shield layer 175 is not limited as long as it can transmit light in the wavelength band of the visible region. The shield layer 175 is connected to the housing and the ground terminal by a conductive wire (not illustrated) or the like. The potential of the shield layer 175 is the same as that of the ground point to which the shield layer 175 is connected.

A planarizing film or a protective film is formed in an upper portion of the display D2. The planarizing film or the protective film is made of a transparent material that can transmit light in the wavelength band of the visible region. The material forming the planarizing film or the protective film is not limited as long as it can transmit light in the wavelength band of the visible region. For example, the planarizing film or the protective film is made of silicon oxide or the like. The antenna A2 is disposed on the display D2. The phase shifter forming layer 130 included in the antenna A2 is disposed to avoid a region above the light emitter 155 included in the display D2.

According to this modification example, the antenna A2 and the display D2 can be manufactured individually. For example, the antenna A2 and the display D2 may be manufactured in different factories. As described above, according to this modification example, flexibility in manufacturing the display antenna 10-2 is improved.

### Modification Example 3

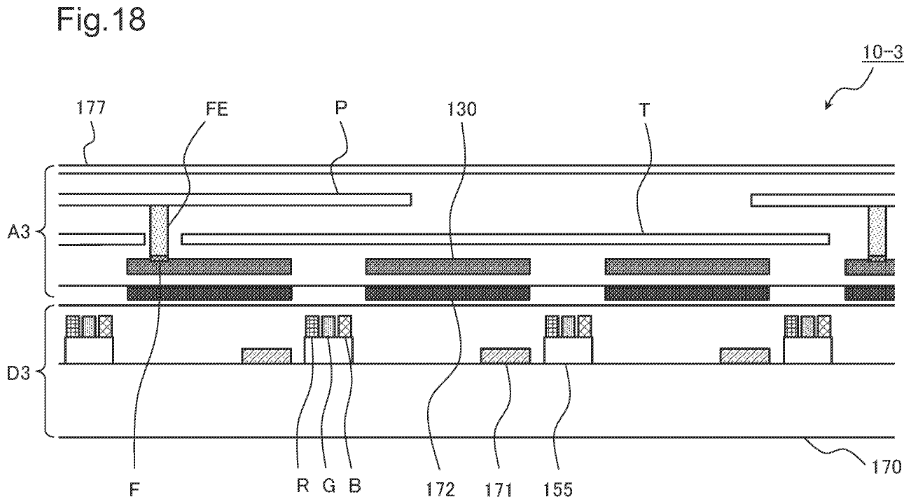

FIG. 18 is a conceptual diagram illustrating an example of a configuration of a display antenna 10-3 according to Modification Example 3. FIG. 18 illustrates an example of a cross-sectional structure of the display antenna 10-3. The display antenna 10-3 has a configuration in which an antenna function (antenna A3) and a display function (display D3) are separated. The antenna A3 is stacked on the display D3. The antenna A3 includes the patch antenna P, the touch electrode T, the feeding electrode FE, the phase shifter forming layer 130, the shield electrode 172, and the protective layer 177. The display D3 includes a plurality of light emitters 155, the substrate 170, and the wiring layer 171. The functions of the antenna and the functions of the display may be integrally formed. In FIG. 18, a portion of the configuration of the display antenna 10-3 is omitted. In the cross-sectional view of FIG. 18, the hatching of some portions is omitted.

The shield electrode 172 is formed in the lowermost layer of the antenna A3. The shield electrode 172 is formed to prevent electromagnetic coupling between the upper side of the shield electrode 172 and the display D3 disposed below the shield electrode 172. A material forming the shield electrode 172 is not particularly limited as long as it has conductivity. For example, the shield electrode 172 is made of a material including metal such as aluminum or copper. The shield electrode 172 is connected to a housing or a ground terminal by a conductive wire (not illustrated) or the like. The shield electrode 172 has the same potential as a ground point to which the shield electrode 172 is connected.

A planarizing film or a protective film is formed on the display D3. The planarizing film or the protective film is made of a transparent material that can transmit light in the wavelength band of the visible region. The material forming the planarizing film or the protective film is not limited as long as it can transmit light in the wavelength band of the visible region. For example, the planarizing film or the protective film is made of silicon oxide or the like. The antenna A3 is disposed on the display D3. The phase shifter forming layer 130 and the shield electrode 172 included in the antenna A3 are disposed to avoid a region above the light emitter 155 included in the display D3.

According to this modification example, the antenna A3 and the display D3 can be manufactured individually. For example, the antenna A3 and the display D3 may be manufactured in different factories. As described above, according to this modification example, flexibility in manufacturing the display antenna 10-3 is improved.

### Modification Example 4

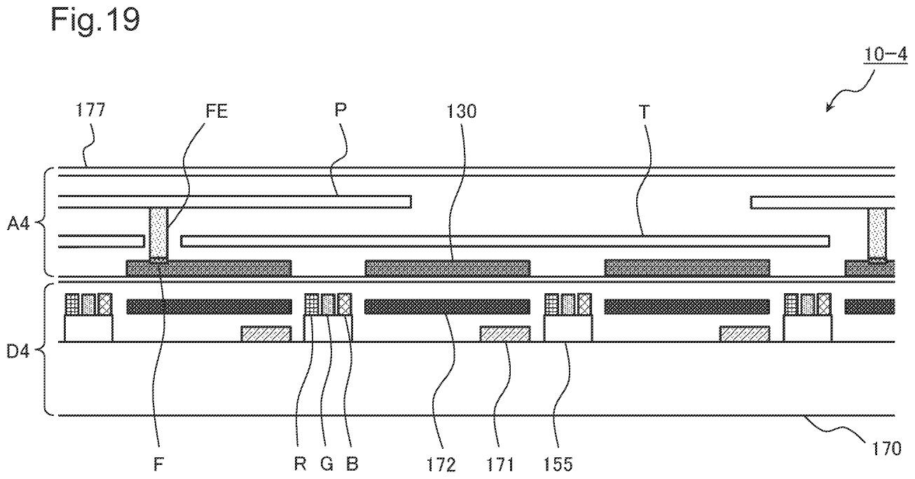

FIG. 19 is a conceptual diagram illustrating an example of a configuration of a display antenna 10-4 according to Modification Example 4. FIG. 19 illustrates an example of a cross-sectional structure of the display antenna 10-4. The display antenna 10-4 has a configuration in which an antenna function (antenna A4) and a display function (display D4) are separated. The antenna A4 is stacked on the display D4. The antenna A4 includes the patch antenna P, the touch electrode T, the feeding electrode FE, the phase shifter forming layer 130, and the protective layer 177. The display D4 includes a plurality of light emitters 155, the substrate 170, the wiring layer 171, and the shield electrode 172. The functions of the antenna and the functions of the display may be integrally formed. In FIG. 19, a portion of the configuration of the display antenna 10-4 is omitted. In the cross-sectional view of FIG. 19, the hatching of some portions is omitted.

The phase shifter forming layer 130 is formed in the lowermost layer of the antenna A4. For example, a planarizing film or a protective film is formed below the phase shifter forming layer 130. The planarizing film or the protective film is made of a transparent material that can transmit light in the wavelength band of the visible region. The material forming the planarizing film or the protective film is not limited as long as it can transmit light in the wavelength band of the visible region. For example, the planarizing film or the protective film is made of silicon oxide or the like.

The planarizing film or the protective film is formed in an upper portion of the display D4. The planarizing film or the protective film is made of a transparent material that can transmit light in the wavelength band of the visible region. The material forming the planarizing film or the protective film is not limited as long as it can transmit light in the wavelength band of the visible region. For example, the planarizing film or the protective film is made of silicon oxide or the like. The shield electrode 172 is disposed between the plurality of light emitters 155. The shield electrode 172 is disposed below the phase shifter 13 in association with the phase shifter 13 included in the phase shifter forming layer 130 included in the antenna A4. The shield electrode 172 is formed to prevent electromagnetic coupling between the upper side of the shield electrode 172 and the wiring layer 171 disposed below the shield electrode 172 or the like. A material forming the shield electrode 172 is not particularly limited as long as it has conductivity. For example, the shield electrode 172 is made of a material including metal such as aluminum or copper. The shield electrode 172 is connected to a housing or a ground terminal by a conductive wire (not illustrated) or the like. The shield electrode 172 has the same potential as a ground point to which the shield electrode 172 is connected. The antenna A4 is disposed on the display D4. The phase shifter forming layer 130 is disposed to avoid a region above the light emitter 155 included in the display D4.

According to this modification example, the antenna A4 and the display D4 can be manufactured individually. For example, the antenna A4 and the display D4 may be manufactured in different factories. As described above, according to this modification example, flexibility in manufacturing the display antenna 10-4 is improved. According to the configuration of this modification example, the phase shifter 13 included in the phase shifter forming layer 130 may not be transparent.

As described above, the display antenna according to the present example embodiment includes the antenna array, the touch sensor, the phase shifter, the display, and the control unit. The display includes a plurality of light emitters that are arranged in a lattice pattern. The touch sensor is disposed to overlap the display. The touch sensor has a structure in which a plurality of touch electrodes that transmit light in the wavelength band of the visible region are arranged in a lattice pattern. The touch electrode also serves as the ground electrode of the patch antenna that is disposed above the touch electrode. The antenna array is disposed to overlap the touch sensor. The antenna array has a structure in which a plurality of patch antennas that transmit light in the wavelength band of the visible region are arranged in a lattice pattern. The phase shifter is disposed in a gap region that is interposed between adjacent light emitters. The phase shifter is connected to at least one of a plurality of patch antennas through the feeding electrode disposed in a through hole formed in the touch sensor. The phase shifter is associated with at least one of the plurality of patch antennas. The phase shifter shifts the phase of the signal to be transmitted and received. The control unit switches connections between the plurality of patch antennas included in the antenna array to configure a phased array antenna. The control unit switches the on and off states of the plurality of touch electrodes included in the touch sensor to detect contact. The control unit detects a contact position of an indicator according to a change in capacitance at an intersection of a row formed by a plurality of touch electrodes that are arranged in the row direction and a column formed by a plurality of touch electrodes that are arranged in the column direction.

The display antenna according to the present example embodiment has a stacked structure of the antenna array and the touch sensor. In the antenna array, an antenna assembly can be configured by a plurality of patch antennas, which makes it possible to change the frequency band of the radio waves to be transmitted and received. In the antenna array, the patch antenna used for transmitting and receiving the radio waves can be selected by switching the connection with the signal source. In the touch sensor, the on and off states of a plurality of touch electrodes can be switched to detect contact. The phased array antenna and the touch sensor are configured in different layers. That is, according to the display antenna of the present example embodiment, the touch sensor and the antenna can be set independently.

The optimum size of the patch antenna used in a frequency band associated to mobile communication after 5G is different from the optimum size of the touch electrode used for the touch sensor. The optimum size of the patch antenna and the optimum pitch between the touch electrodes differ depending on the frequency band associated to the mobile communication after 5G. According to the present example embodiment, the touch sensor and the antenna can be set independently. That is, the configuration of the present example embodiment is suitable for a touch sensor-antenna device that is used for the mobile communication after 5G.

In an aspect of the present example embodiment, the control unit sets the touch electrode disposed below the patch antenna that functions as the antenna to the off state. According to this aspect, the touch electrode disposed below the patch antenna that operates as the antenna can function as the ground electrode of the patch antenna.

In an aspect of the present example embodiment, the control unit switches the patch antenna disposed above the touch electrode in the active state to the off state. According to this aspect, the sensitivity of the touch electrode can be improved by switching the patch antenna disposed above the touch electrode to the off state.

In an aspect of the present example embodiment, the control unit sets a plurality of patch antennas disposed above the touch electrodes in the active state to the same potential in such a way as to function as a portion of the touch sensor. According to this aspect, the patch antenna disposed above the touch electrode functions as a portion of the touch sensor, which makes it possible to improve the sensitivity of the touch electrode.

In an aspect of the present example embodiment, the control unit displays the user interface associated with a position in the touch sensor on the display. The control unit associates the detected contact position of the indicator with the input image displayed at the contact position on the display to determine the selected input image. According to this aspect, it is possible to implement the user interface that receives the operation of the user in accordance with the selection of the input image displayed on the display.

### Second Example Embodiment

Next, a display antenna according to a second example embodiment will be described with reference to the drawings. The display antenna according to the present example embodiment is different from the display antenna according to the first example embodiment in that a patch antenna and a phase shifter are connected by electromagnetic coupling.

### (Configuration)

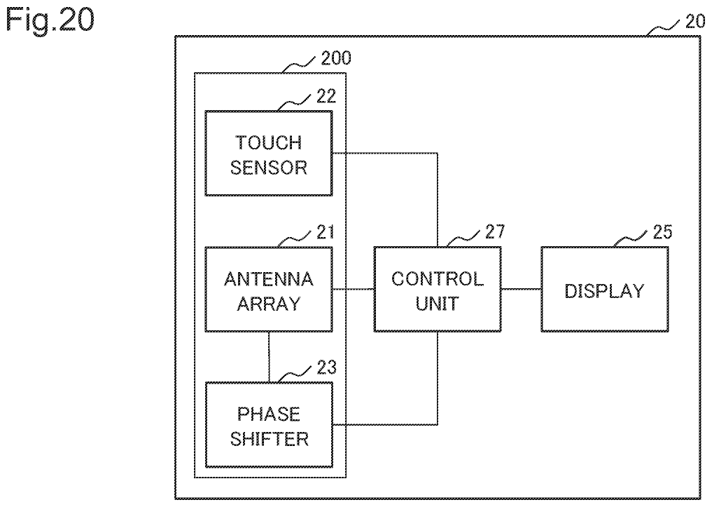

FIG. 20 is a block diagram illustrating an example of a configuration of a display antenna according to the present disclosure. A display antenna 20 includes an antenna array 21, a touch sensor 22, a phase shifter 23, a display 25, and a control unit 27. The antenna array 21, the touch sensor 22, and the phase shifter 23 constitute an antenna device 200. The control unit 27 may be added to the antenna device 200. The control unit 27 may be disposed outside the display antenna 20. In this case, the display antenna 20 includes the antenna array 21, the touch sensor 22, the phase shifter 23, and the display 25.

The antenna array 21 has the same configuration as the antenna array 11 according to the first example embodiment. The antenna array 21 includes a plurality of patch antennas. The patch antenna is a transparent electrode capable of transmitting light in a wavelength bands of a visible region and a near-infrared region. For example, the visible region is a wavelength band of 380 to 800 nm. For example, the near-infrared region is a wavelength band of 0.7 to 2.5 μm (micrometer). The antenna array 21 may be transparent to a wavelength band of light used for detecting contact.

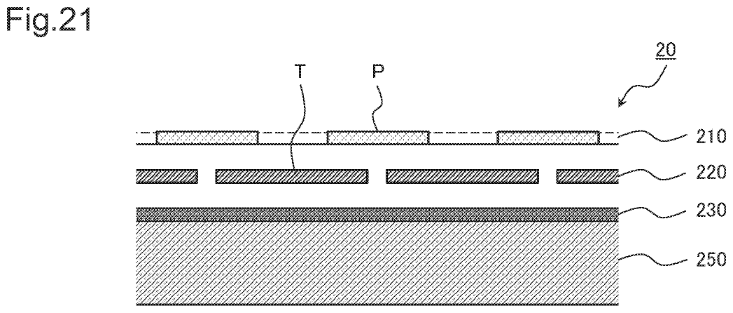

FIG. 21 is a cross-sectional view illustrating an example of a structure of the display antenna according to the present disclosure. FIG. 21 illustrates a portion of the configuration of the display antenna 20. FIG. 21 illustrates an antenna layer 210, a touch sensor layer 220, a phase shifter forming layer 230, and a display forming layer 250. The display 25 is configured in the display forming layer 250. The phase shifter forming layer 230 including the phase shifter 23 is disposed above the display forming layer 250. The touch sensor layer 220 including the touch electrode T that also serves as a ground electrode is disposed above the phase shifter forming layer 230. The antenna layer 210 including a plurality of patch antennas P is disposed above the touch sensor layer 220. A microstrip line (not illustrated) comes out from the phase shifter 23 formed in the phase shifter forming layer 230. The microstrip line coming out from the phase shifter 23 is connected to the patch antenna P disposed above the phase shifter 23 by electromagnetic coupling.

The patch antenna P is fed with power by an electromagnetic coupling feeding method. An opening portion (also referred to as a slot) is formed in the touch sensor layer 220 below the patch antenna P. The patch antenna P is electromagnetically coupled with the microstrip line coming out from the phase shifter 23 formed in the phase shifter forming layer 230 through the slot in the touch sensor layer 220. The phase shifter 23 corresponds to a microstrip line. The patch antenna P is excited by the electromagnetic coupling between the microstrip line coming out from the phase shifter 23 and the patch antenna P through the slot. For example, impedance matching can be performed by disposing an open end of the phase shifter 23 at a position away from immediately below the slot by about a distance that is ¼ of the wavelength of the radio waves to be transmitted and by adjusting the dimensions of the slot. For example, the slot has a rectangular shape. For example, the slot may have a shape, such as a dog-bone shape, other than the rectangular shape. The microstrip line coming out from the phase shifter 23 and the patch antenna P may be electromagnetically coupled by proximity coupling feeding without passing through the slot.

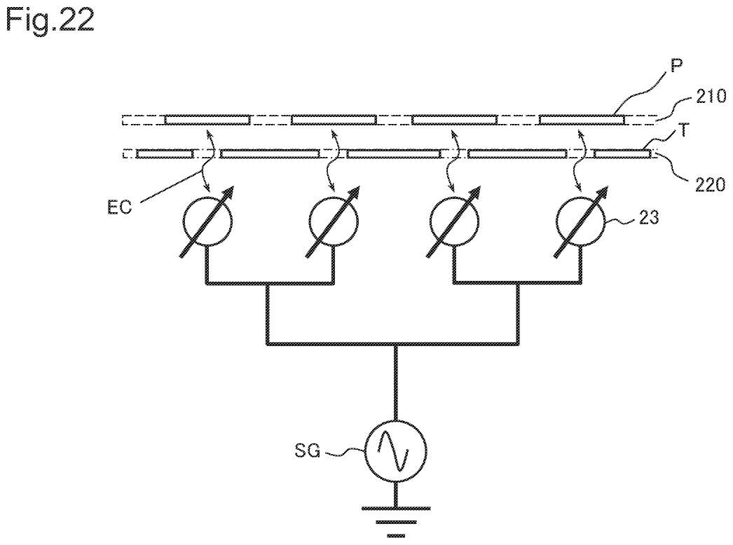

FIG. 22 is a conceptual diagram illustrating the electromagnetic coupling between the patch antenna and the phase shifter according to the present disclosure. In FIG. 22, the microstrip line coming out from the phase shifter 23 is omitted. A plurality of touch electrodes T constituting the antenna layer 210 are set to the same potential through wires (not illustrated). Each of the plurality of patch antennas P is connected to the phase shifter 23 (microstrip line) by electromagnetic coupling EC through the through hole formed in the touch sensor layer 220 configured by the plurality of touch electrodes T. An input end of the phase shifter 23 is connected to the signal source SG. A signal to be transmitted that has been supplied through a signal line (not illustrated) is transmitted to the patch antenna P by the electromagnetic coupling EC according to high-frequency power supplied from the signal source SG to the phase shifter 23. The signal transmitted to the patch antenna P is transmitted as a radio signal.

The touch electrode T has the same configuration as the touch electrode T according to the first example embodiment. The touch electrode T is disposed above the phase shifter 23 included in the phase shifter forming layer 230. The touch electrode T also serves as the ground electrode of the patch antenna P. The touch electrode T is grounded through a circuit (not illustrated). The plurality of touch electrodes T are arranged in a two-dimensional array.

The plurality of patch antennas P are disposed above the touch electrodes T. The plurality of patch antennas P are connected to the microstrip lines coming out from the phase shifters 23 disposed below the patch antennas P by the electromagnetic coupling EC. The patch antenna P transmits and receives a signal to and from the phase shifter 23 disposed below the patch antenna P. The patch antenna P transmits the signal received from the phase shifter 23 as the radio signal. The patch antenna P transmits the received radio signal to the phase shifter 23.

The signal to be transmitted is output from a transmission circuit (not illustrated). The signal output from the transmission circuit reaches the phase shifter 23 through a signal line (not illustrated). The phase of the signal to be transmitted that has reached the phase shifter 23 is shifted by the phase shift amount set in phase shifter 23. The signal that has reached the microstrip line coming out from the phase shifter 23 is propagated to the patch antenna P disposed above the phase shifter 23 by the electromagnetic coupling EC. The signal propagated to the patch antenna P is transmitted as the radio wave in the wavelength band to be transmitted. The transmission direction of the radio wave transmitted from the display antenna 20 is controlled for each antenna assembly.

The signal to be received that has been received by the patch antenna P is transmitted to the phase shifter 23 disposed below the patch antenna P by the electromagnetic coupling EC. The phase of the signal received by the phase shifter 23 is shifted by the phase shift amount set in the phase shifter 23. The signal whose phase has been shifted is received by a receiving circuit (not illustrated) through a signal line. Information included in the signal received by the receiving circuit is decoded by a decoder (not illustrated).

The control unit 27 has the same configuration as the control unit 17 according to the first example embodiment. The control unit 27 controls the connection states of the plurality of patch antennas P constituting the antenna array 21 to form an antenna assembly. The control unit 27 sets the size of the antenna assembly in accordance with the frequency band of the radio waves to be transmitted and received. The control unit 27 turns on and off the switch (not illustrated) disposed between the patch antennas P to change a combination of the patch antennas P constituting the antenna assembly. As a result, the size of the antenna assembly is set in accordance with the frequency band of the radio waves to be transmitted and received. The control unit 27 grounds the touch electrodes T disposed below the patch antennas P set as the antenna assembly. The touch electrode T disposed below the patch antenna P functions as the ground electrode of the patch antenna P.

The control unit 27 also sets the phase shift amount of the phase shifter 23. The control unit 27 turns on and off the phase shift switch disposed in phase shifter 23 to set the phase shift amount of the phase shifter 23. The control unit 27 supplies the signal to be transmitted to the signal line connected to the input end of the phase shifter 23 whose phase shift amount has been set. The control unit 27 turns on the switch (not illustrated) that switches the connection between the signal source (not illustrated) and the phase shifters 23 associated with the patch antennas P constituting the antenna assembly used for transmitting radio waves. The signal source is a high-frequency power source that is used for transmitting the radio waves to be transmitted. The signal source supplies high-frequency power corresponding to the frequency band of the radio waves to be transmitted or the transmission strength of the radio waves. The antenna assembly including the patch antennas P associated with the phase shifters 23 connected to the signal source is supplied with high-frequency power from the signal source. As a result, the phase of the signal to be transmitted that has been supplied from the signal line is shifted according to the phase shift amount of the phase shifter 23, and the signal is transmitted to the patch antennas P constituting the antenna assembly. The signal transmitted to the patch antenna P is transmitted as the radio signal from the patch antenna P.

The control unit 27 sequentially switches the active row sensor TS_{X} and column sensor TS_{Y} to scan contact. The row sensor TS_{X} detects contact in the row direction (X direction). The column sensor TS_{Y} detects contact in the column direction (Y direction). The control unit 27 turns off the switch between the signal source SG and the phase shifter 23 associated with the patch antenna P located above the touch electrode T that is being scanned. As a result, the supply of the high-frequency power to the phase shifter 23 associated with the patch antenna P is stopped in accordance with the scanning of contact detection. The control unit 27 detects a contact position according to a change in capacitance at an intersection of the row sensor TS_{X} and the column sensor TS_{Y}.

The control unit 27 controls display on the display 25. The control unit 27 causes a plurality of light emitters 255 constituting the display 25 to emit light in such a way that a user interface for receiving the input of an operation is displayed. The control unit 27 causes the plurality of light emitters 255 to emit light in such a way that display information for performing selection and operation at the detection position by the touch sensor 22 is displayed in association with the detection position. In a case where the user interface is not displayed, the control unit 27 may cause the plurality of light emitters 255 constituting the display 25 to emit light in such a way that an image that is not related to the touch sensor is displayed. A display control unit (not illustrated) different from the control unit 27 may be used for display control of the display 25.

As described above, the display antenna 20 can simultaneously exhibit the functions of the touch sensor and the functions of the phased array antenna. The display antenna 20 may be used as the touch sensor without using the functions of the phased array antenna. The display antenna 20 may be used as the phased array antenna without using the functions of the touch sensor.

As described above, the display antenna according to the present example embodiment includes the antenna array, the touch sensor, the phase shifter, the display, and the control unit. The display includes a plurality of light emitters that are arranged in a lattice pattern. The touch sensor is disposed to overlap the display. The touch sensor has a structure in which a plurality of touch electrodes that transmit light in the wavelength band of the visible region are arranged in a lattice pattern. The touch electrode also serves as the ground electrode of the patch antenna that is disposed above the touch electrode. The antenna array is disposed to overlap the touch sensor. The antenna array has a structure in which a plurality of patch antennas that transmit light in the wavelength band of the visible region are arranged in a lattice pattern. The phase shifter is disposed in a gap region that is interposed between adjacent light emitters. The phase shifter is connected to at least one of the plurality of patch antennas by electromagnetic coupling through the through hole formed in the touch sensor. The phase shifter is associated with at least one of the plurality of patch antennas. The phase shifter shifts the phase of the signal to be transmitted and received. The control unit switches the connection between a plurality of patch antennas included in the antenna array to configure a phased array antenna. The control unit switches the on and off states of the plurality of touch electrodes included in the touch sensor to detect contact. The control unit detects a contact position of an indicator according to a change in capacitance at an intersection of a row formed by a plurality of touch electrodes that are arranged in the row direction and a column formed by a plurality of touch electrodes that are arranged in the column direction.

The display antenna according to the present example embodiment has a stacked structure of the antenna array and the touch sensor. In the antenna array, an antenna assembly can be configured by a plurality of patch antennas, which makes it possible to change the frequency band of the radio waves to be transmitted and received. In the antenna array, the patch antenna used for transmitting and receiving the radio waves can be selected by switching the connection with the signal source. In the touch sensor, the on and off states of a plurality of touch electrodes can be switched to detect contact. The phased array antenna and the touch sensor are configured in different layers. That is, according to the display antenna of the present example embodiment, the touch sensor and the antenna can be set independently. According to the display antenna of the present example embodiment, since a plurality of patch antennas are connected to the phase shifters by electromagnetic coupling, it is possible to simplify wiring.

The patch antenna according to an aspect of the present example embodiment is connected to the phase shifter disposed below the patch antenna by electromagnetic coupling through the through hole formed in the touch sensor. According to this aspect, the patch antenna and the phase shifter that face each other through the through hole formed in the touch sensor can communicate with each other by electromagnetic coupling.

### Third Example Embodiment

Next, a display antenna according to a third example embodiment will be described with reference to the drawings. The display antenna according to the present example embodiment has a configuration obtained by simplifying the display antennas according to the first to second example embodiments.

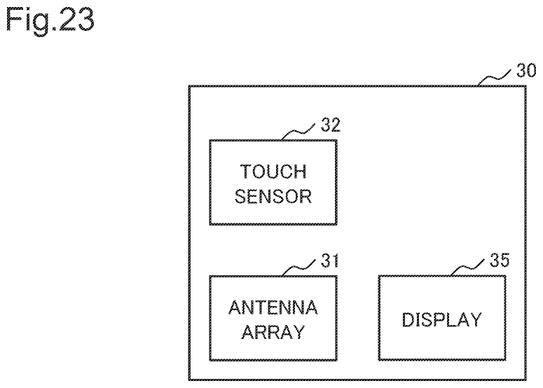

FIG. 23 is a block diagram illustrating an example of a configuration of the display antenna according to the present disclosure. A display antenna 30 includes an antenna array 31, a touch sensor 32, and a display 35. The display 35 includes a plurality of light emitters that are arranged in a lattice pattern. The touch sensor 32 is disposed to overlap the display 35. The touch sensor 32 has a structure in which a plurality of touch electrodes that transmit light in a wavelength band of a visible region are arranged in a lattice pattern. The touch electrode also serves as the ground electrode of the patch antenna that is disposed above the touch electrode. The antenna array 31 is disposed to overlap the touch sensor 32. The antenna array 31 has a structure in which a plurality of patch antennas that transmit light in the wavelength band of the visible region are arranged in a lattice pattern.

The display antenna according to the present example embodiment has a stacked structure of the antenna array and the touch sensor. In the antenna array, an antenna assembly can be configured by a plurality of patch antennas, which makes it possible to change the frequency band of the radio waves to be transmitted and received. In the antenna array, the connection with the signal source can be switched to select the patch antenna to be used for transmitting and receiving radio waves. In the touch sensor, the on and off states of a plurality of touch electrodes can be switched to detect contact. Therefore, the antenna array and the touch sensor can be controlled independently. That is, according to the display antenna of the present example embodiment, the touch sensor and the antenna can be set independently.

### (Hardware)

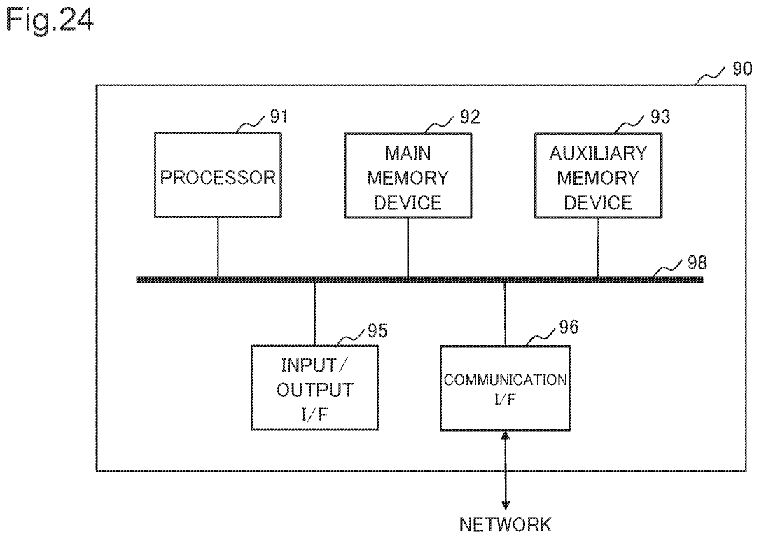

Next, a hardware configuration for executing the control or the processes according to each of the example embodiments of the present disclosure will be described with reference to the drawings. Here, an information processing device (computer) illustrated in FIG. 24 will be described as an example of the hardware configuration. The information processing device illustrated in FIG. 24 is an example of the configuration for executing the control or the processes according to each of the example embodiments and is not intended to limit the scope of the present disclosure.

An information processing device 90 includes a processor 91, a main memory device 92, an auxiliary memory device 93, an input/output interface 95, and a communication interface 96. In FIG. 24, the interface is abbreviated as I/F. The processor 91, the main memory device 92, the auxiliary memory device 93, the input/output interface 95, and the communication interface 96 are connected to one another via a bus 98 in such a way that data communication can be performed. The processor 91, the main memory device 92, the auxiliary memory device 93, and the input/output interface 95 are connected to a network, such as the Internet or an intranet, via the communication interface 96.

The processor 91 deploys a program (instruction) stored in the auxiliary memory device 93 or the like in the main memory device 92. For example, the program is a software program for executing the control or the processes according to each of the example embodiments. The processor 91 executes the program deployed in the main memory device 92. The processor 91 executes the program in such a way that the control or the processes according to each of the example embodiments are executed.

The main memory device 92 has a region in which the program is deployed. The processor 91 deploys the program stored in the auxiliary memory device 93 or the like in the main memory device 92. The main memory device 92 is implemented by, for example, a volatile memory such as a dynamic random access memory (DRAM). A non-volatile memory, such as a magneto resistive random access memory (MRAM), may be configured/added as the main memory device 92.

The auxiliary memory device 93 stores various types of data such as programs. The auxiliary memory device 93 is implemented by a local disk such as a hard disk or a flash memory. A configuration can also be adopted in which various types of data are stored in the main memory device 92 and the auxiliary memory device 93 is omitted.

The input/output interface 95 is an interface for connecting the information processing device 90 with a peripheral device based on standards or specifications. The communication interface 96 is an interface for connecting to an external system or device via a network, such as the Internet or an intranet, based on standards or a specifications. The input/output interface 95 and the communication interface 96 may be combined as the interface connected to the external device.

Input devices, such as a keyboard, a mouse, and a touch panel, may be connected to the information processing device 90 as necessary. These input devices are used to input information or settings. In a case where a touch panel is used as the input device, a screen having the functions of the touch panel serves as an interface. The processor 91 and the input device are connected to each other via the input/output interface 95.

The information processing device 90 may be provided with a display device for displaying information. In a case where the display device is provided, the information processing device 90 includes a display control device (not illustrated) for controlling display on the display device. The information processing device 90 and the display device are connected to each other via the input/output interface 95.

The information processing device 90 may be provided with a drive device. The drive device mediates reading of data or a program stored in a recording medium (program recording medium) or writing of a processing result of the information processing device 90 to the recording medium between the processor 91 and the recording medium. The information processing device 90 and the drive device are connected to each other via the input/output interface 95.

The example of the hardware configuration for enabling the control or the processes according to each of the example embodiments of the present disclosure has been described above. The hardware configuration illustrated in FIG. 24 is an example of the hardware configuration for executing the control or the processes according to each of the example embodiments and is not intended to limit the scope of the present disclosure. A program for causing a computer to execute the control or the processes according to each of the example embodiments is also included in the scope of the present disclosure.

A program recording medium on which the program according to each of the example embodiments is recorded is also included in the scope of the present disclosure. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium, such as a flexible disk, or other recording media. In a case where the program executed by the processor is recorded on the recording medium, the recording medium corresponds to the program recording medium.

The components according to each of the example embodiments may be combined in any manner. The components according to each of the example embodiments may be implemented by software. The components according to each of the example embodiments may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A display antenna comprising:
a display including a plurality of light emitters arranged in a lattice pattern;
a touch sensor that is disposed to overlap the display and in which a plurality of touch electrodes transmitting light in a wavelength band of a visible region are arranged in a lattice pattern; and
an antenna array that is disposed to overlap the touch sensor and in which a plurality of patch antennas transmitting the light in the wavelength band of the visible region are arranged in a lattice pattern, wherein
the touch electrode also serves as a ground electrode of the patch antenna disposed above the touch electrode.

2. The display antenna according to claim 1, comprising
a phase shifter disposed in a gap region interposed between the light emitters adjacent to each other, wherein
the phase shifter is associated with at least one of the plurality of patch antennas, and
the phase shifter is configured to shift a phase of a signal to be transmitted and received.

3. The display antenna according to claim 2, wherein
the phase shifter is connected to at least one of the plurality of patch antennas through a feeding electrode disposed in a through hole formed in the touch sensor.

4. The display antenna according to claim 2, wherein
the phase shifter is connected to at least one of the plurality of patch antennas by electromagnetic coupling through a through hole formed in the touch sensor.

5. The display antenna according to claim 4, wherein
the patch antenna is connected to the phase shifter disposed below the patch antenna by electromagnetic coupling through the through hole formed in the touch sensor.

6. The display antenna according to claim 1, comprising
a controller that comprises
a memory storing instructions; and
a processor connected to the memory and configured to execute the instructions to
switch a connection between the plurality of patch antennas included in the antenna array to configure a phased array antenna,
switch on and off states of the plurality of touch electrodes included in the touch sensor to detect contact, and
detect a contact position of an indicator according to a change in capacitance at an intersection of a row formed by the plurality of touch electrodes arranged in a row direction and a column formed by the plurality of touch electrodes arranged in a column direction.

7. The display antenna according to claim 6, wherein
the processor of the controller is configured to execute the instructions to
set the touch electrode disposed below the patch antenna functioning as an antenna to the off state.

8. The display antenna according to claim 6, wherein
the processor of the controller is configured to execute the instructions to
set the patch antenna disposed above the touch electrode in an active state to an off state.

9. The display antenna according to claim 8, wherein
the processor of the controller is configured to execute the instructions to
set the plurality of patch antennas disposed above the touch electrode in the active state to the same potential to function as a portion of the touch sensor.

10. The display antenna according to claim 9, wherein
the processor of the controller is configured to execute the instructions to
display a user interface associated with a position in the touch sensor on the display and associates the detected contact position of the indicator with an input image displayed at the contact position in the display to determine the selected input image.
